(19) United States
(12) Patent Application Publication
(10) Pub. No.: US 2012/0102175 A1
(43) Pub. Date: Apr. 26, 2012

(54) Computer System, Simulation Method and Program

(75) Inventor: Yasuhiro ITO, Kodaira (JP)

(73) Assignee: Hitachi, Ltd., Tokyo (JP)

(21) Appl. No.: 13/277,356

(22) Filed: Oct. 20, 2011

(30) Foreign Application Priority Data
Oct. 26, 2010 (JP) 2010-239755

(51) Int. Cl. G06F 15/173

(52) U.S. Cl. 709/223

(57) ABSTRACT

In a computer environment in which different types of simulations run, a speculative communication method can be performed on a combination of any model and any simulator. The simulations are divided into one or more groups and mounted on an execution node in which a virtual OS runs. A communication protocol simulation device which is a control program of inter-simulation communication and a virtual OS execution management server device which is an execution control program of a virtual OS group run on a management node separately from the virtual OS group that executes the simulations. When the communication protocol simulation device of the management node detects a WAR hazard, the virtual OS execution management server device instructs a virtual OS execution management client device so that a virtual OS in which the WAR hazard occurs returns to a stored intermediate state and re-executes the simulation to a predetermined time.

### CLAIM OF PRIORITY

The present application claims priority from Japanese patent application JP2010-239755 filed on Oct. 26, 2010, the content of which is hereby incorporated by reference into this application.

### BACKGROUND OF THE INVENTION

The present invention relates to a communication technique of a simulation in which multiple simulators work together in a development of an embedded system.

The embedded system includes a mechanism that is an object to be controlled, hardware that performs control calculation on the basis of a physical quantity received from the mechanism and outputs a control value to the mechanism, and software that runs on the hardware. For example, an embedded system for controlling a vehicle engine includes an engine to be controlled, an electronic device, such as a microcomputer, which controls the engine, and software that runs on the electronic device.

Behavior of the software included in the embedded system strongly depends on the mechanism to be controlled and a configuration of the hardware, so that it is necessary to analyze behavior of a combination of the mechanism, the hardware, and the software. In recent years, as vehicles and electronic devices become more reliable and more functional, embedded systems become more complex, so that hardware and software components are divided into smaller components to be developed separately so as to shorten a development period, and developments are performed simultaneously at multiple locations. As the developments are performed separately, performance deficiencies and specification problems, which are found not only when an operation test of each component is performed, but also when the components are assembled, increase. Therefore, delay of development occurs often due to rework in a final stage of the development before shipping product, so that degradation of development efficiency becomes a problem.

To address the problem, a performance evaluation and verification method by a simulation in which mechanism, hardware, and software work together in a collaborative manner at the time of design is beginning to be used. (US2009/0281779)

### BRIEF SUMMARY OF THE INVENTION

In the above-described simulation in which mechanism, hardware, and software work together in a collaborative manner, simulators that can be used are different depending on a configuration of a mechanism and hardware to be simulated, and simulation models that have been created for specific simulators are accumulated, so that a collaborative simulation of an entire product level is performed by connecting different simulators with each other. To realize the collaborative simulation, it is necessary to establish communication among multiple simulations of different types. As a generally used method, there is a method in which predetermined data structures are exchanged at a certain period of time in a simulation. Hereinafter, this method is referred to as “polling method”.

In the polling method, it is possible to simplify a data exchange method between simulations. On the other hand, it is necessary to exchange data periodically even when no meaningful communication is performed on an actual simulation. The data exchange between simulations generates communication with a different process run in the same computer or another computer. A large amount of communication between processes causes an execution speed of a program to decrease significantly.

Therefore, to perform simulations efficiently, it is necessary to adjust communication period so that the number of data exchanges in all communications between simulations is minimum. In a collaborative simulation of the entire embedded system, the number of communications between simulations is about 1000 in a case of, for example, a vehicle. It is actually impossible to optimize communication period of all the communications, so that this is a problem in putting the simulations to practical use.

A method considered to address the problem is change the data exchange method between simulations. Specifically, compared with the polling method which requires communication between simulators at a certain period of time, it is possible to increase data exchange efficiency by establishing communication between processes only when an object to be simulated performs an external access. Hereinafter, this method is referred to as “event driven method”. On the other hand, in the event driven method, each simulation runs completely independently from each other, so that the problem described below occurs.

The simulations running independently from each other can run at different execution speeds according to a load and usable resources thereof. Therefore, there is a risk that the hazards defined below occur when data exchange occurs.
WAR (Write After Read) hazard: a state in which a simulation on the data receiving side advances further than a simulation on the data transmitting side.
RAW (Read After Write) hazard: a state in which a simulation on the data transmitting side advances further than a simulation on the data receiving side.

In the case of the latter RAW hazard, it is possible to perform simulation normally by temporarily stopping the simulation on the data transmitting side until both simulations reach the same time. On the other hand, the WAR hazard is a state in which the simulation on the receiving side continuously performs simulation ignoring data that would have been transmitted from the transmitting side, so that there is a risk that a result different from the actual one is outputted. Thus, the simulation needs to be re-executed.

The state of occurrence of the WAR hazard varies depending on a state of computing resources and an operation of the object to be simulated, so that there is no reproducibility and it is difficult to predict an occurrence of the WAR hazard or take measures against the WAR hazard. Therefore, a method is considered in which a correct simulation result is acquired by re-executing the simulation from the middle of the simulation when the WAR hazard occurs. This method is referred to as “speculative communication method” and the speculative communication method is disclosed in US2009/0281779. However, in the speculative communication method described in US2009/0281779, each simulator requires an additional function to store an execution state of the simulation and returns to the stored state when the hazard occurs, that is, a function to re-execute the simulation. Therefore, it is impossible to apply the speculative communication method to an existing simulator that does not have the function.

The present invention provides a computer system, a simulation method, and a program thereof, in which the speculative communication method can be performed on a combination of any model and any simulator.

The present invention provides a computer system in which a management node and multiple execution nodes having a simulator are connected via a network. When one of the execution nodes transmits a data transmission request to another execution node via the management node at a predetermined time, if simulation time of the simulator of the other execution node advances further than the predetermined time, the management node controls the other execution node to re-execute the simulation from a restoration point before the predetermined time to the predetermined time and transmit the data requested to be transmitted after the re-execution to the execution node that transmitted the data transmission request.

Also, the present invention provides a simulation method of a computer system in which a management node and multiple execution nodes that execute a simulation are connected via a network. When one of the execution nodes transmits a data transmission request to another execution node via the management node at a predetermined time, if simulation time of the simulation of the other execution node advances further than the predetermined time, the management node issues an re-execution instruction to the other execution node to re-execute the simulation from a restoration point before the predetermined time to the predetermined time and controls the other node to transmit the data requested to be transmitted after the re-execution to the execution node that transmitted the data transmission request.

Further, the present invention provides a program executed in a processing unit of a management node connected to multiple execution nodes that execute a simulation via a network. When one of the execution nodes transmits a data transmission request to another execution node via the management node at a predetermined time, the program causes the processing unit to determine whether or not simulation time of the simulation of the other execution node advances further than the predetermined time, and if determining that the simulation time advances further than the predetermined time, issue an re-execution instruction to the other execution node to re-execute the simulation from a restoration point before the predetermined time to the predetermined time and control the other node to transmit the data requested to be transmitted after the re-execution to the execution node that transmitted the data transmission request.

Specifically, in an exemplary embodiment of the present invention, simulations are divided into one or more groups and mounted on a virtual operating system (OS). A control program of inter-simulation communication and an execution control program of a virtual OS group run separately from the virtual OS group that executes the simulations. When the inter-simulation communication control program detects a WAR hazard, the inter-simulation communication control program instructs a virtual OS in which the WAR hazard occurs to return to a stored intermediate state and re-execute the simulation to a predetermined time.

According to the present invention, an intermediate execution state is stored and returning and re-execution are performed for each virtual OS, so that a function of returning is not necessary for each simulator, and a speculative communication method can be used in any simulator.

### BRIEF DESCRIPTION OF THE DRAWINGS

Embodiment of the present invention will be described in detail based on the following figures, wherein:

FIG. 1 is a diagram showing a schematic configuration of a computer simulation system according to a first embodiment;

FIG. 2A is a diagram showing a configuration example of an embedded system which is an object to be simulated according to the first embodiment;

FIG. 2B is a diagram showing a configuration example of an ECU (electronic control unit) in the object to be simulated according to the first embodiment;

FIG. 3 is a diagram showing a basic configuration example of a computer in a computer system according to the first embodiment;

FIG. 4 is a diagram showing a basic configuration of a cluster-type parallel computing system according to the first embodiment;

FIG. 5 is a diagram showing a detailed configuration example of a simulation system according to the first embodiment;

FIG. 6 is a flowchart for explaining an operation of speculative communication between simulators according to the first embodiment;

FIG. 7 is a diagram showing a configuration example of a simulator used in a collaborative simulation according to the first embodiment;

FIG. 8 is a diagram showing a format example of a data transmission request transmitted in the collaborative simulation according to the first embodiment;

FIG. 9 is a diagram for explaining an operation of a simulation execution state storage period adaptive control according to the first embodiment;

FIG. 10 is a flowchart for explaining details of one step in the operation flow in FIG. 6 according to the first embodiment;

FIG. 11 is a flowchart for explaining details of another step in the operation flow in FIG. 6 according to the first embodiment;

FIG. 12 is a flowchart for explaining details of a step in the operation flow in FIG. 9 according to the first embodiment;

FIG. 13 is a diagram for explaining data stored in an execution state storage section in FIG. 5 according to the first embodiment; and

FIG. 14 is a diagram for explaining a function of a communication protocol simulation device in FIG. 5 according to the first embodiment.

### DETAILED DESCRIPTION OF THE INVENTION

Hereinafter, various embodiments of the present invention will be described with reference to the drawings. In the present specification, a program executed by a computer included in each node may be represented as “device” or “section”. For example, a virtual OS execution control program may be represented as “virtual OS execution management device” or “virtual OS execution management section”, and an inter-simulation communication control program may be represented as “communication protocol simulation device” or “communication protocol simulation section”.

### First Embodiment

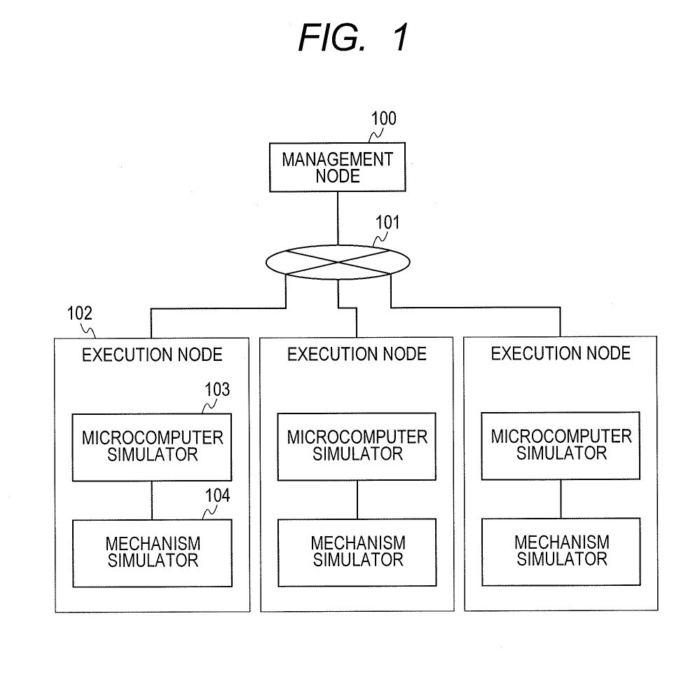

FIG. 1 shows a schematic functional block configuration of a computer system that executes a simulation according to a first embodiment. The computer system of the present embodiment is a simulation system that enables a use of a speculative communication method on a combination of any simulators. In the present computer system, one or multiple execution nodes 102 are connected to one management node 100 via a network 101. As described later, each node has a computer including a central processing unit (CPU) that is a processor, a storage section such as a memory, and an input/output interface section such as a network interface.

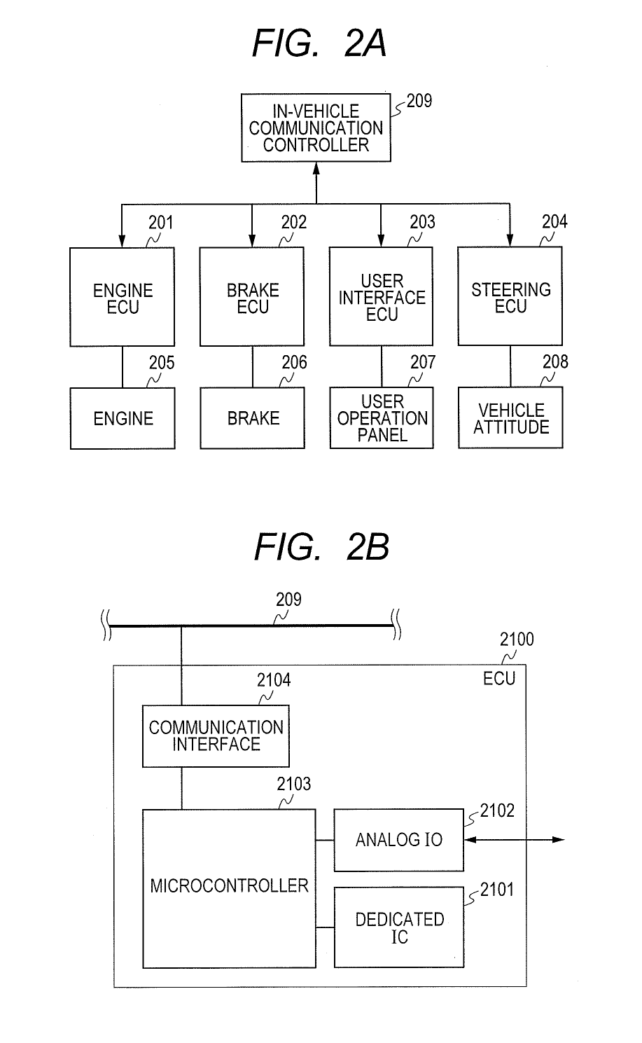

FIG. 2A is a diagram showing a configuration example of an embedded system to which the present computer system is applied. The present configuration example illustrates a control system of a vehicle. In FIG. 2A, an engine 205, a brake 206, a user operation panel 207, and a vehicle attitude 208, which are mechanisms, are respectively connected to an engine ECU 201, a brake ECU 202, a user interface ECU 203, and a steering ECU 204, which are electronic control units (ECUs) controlling the above mechanisms. In the control system, the ECUs are connected to each other by an in-vehicle communication controller 209, so that the ECUs operate collaboratively.

In the same manner as an ECU 2100 shown in FIG. 2B as an example of ECUs, each ECU includes a communication interface 2104 for connecting to the in-vehicle communication controller 209, a microcontroller 2103 connected to the communication interface 2104, a dedicated IC 2101 connected to the microcontroller 2103 and an analog IO 2102 connected to the microcontroller 2103. The analog IO 2101 is connected to the mechanisms.

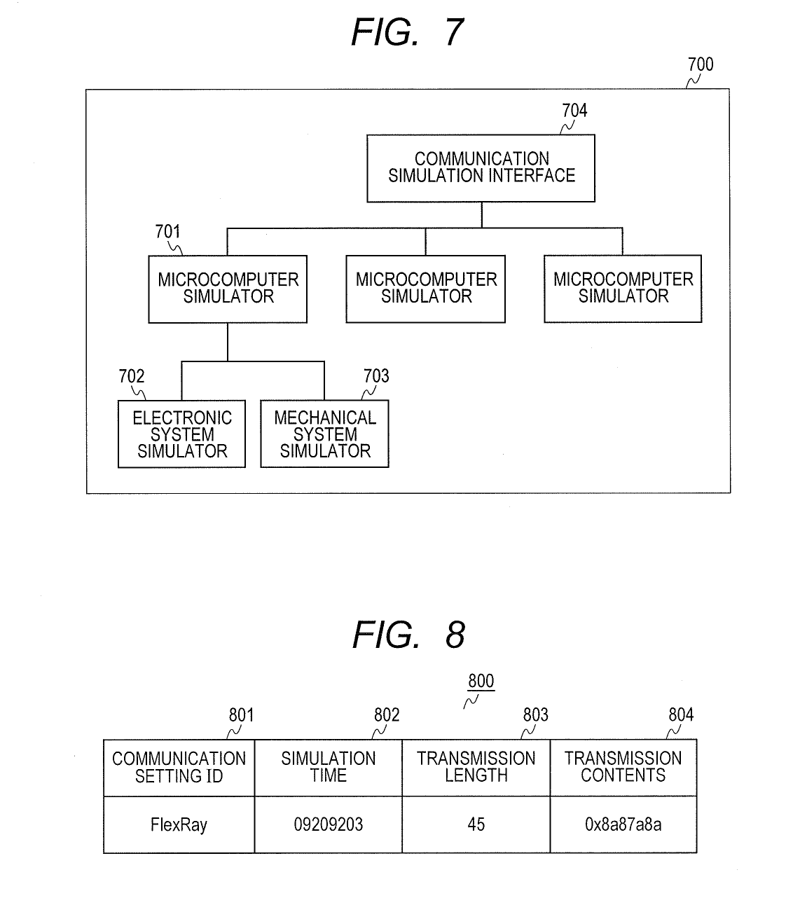

FIG. 7 shows an example of a simulator configuration that verifies the entire system of an embedded system such as a vehicle control system, which is an object to be simulated of the present embodiment. A simulator configuration 700 uses a mechanical system simulator 703 suitable to the mechanisms for the analog IO 2102 connected to the mechanisms and uses an electronic system simulator 702 to simulate the dedicated IC 2101. A microcomputer simulator 701 is generally used to simulate the microcontroller 2103 and the communication interface 2104. In this connection, as shown in FIG. 2A, multiple ECUs are connected by a single communication line, so that a communication simulation interface 704, which performs data exchange and arbitration between the microcomputer simulators, is used. Although multiple microcomputer simulators in FIG. 7 are respectively connected to both the electronic system simulator 702 and the mechanical system simulator 703, please note that the drawings thereof are omitted for the sake of simplicity.

Generally, physical quantities are directly exchanged in the communication between the microcomputer simulator 701 and the mechanical system simulator 703 or the electronic system simulator 702, so that the communication is characterized by being performed periodically. On the other hand, the communication between the microcomputer simulators 701 is based on some communication protocol, and the communication is characterized in that data is exchanged non-periodically. In the simulator configuration in FIG. 7, each ECU is connected to multiple ECUs, so that it is necessary to support many-to-many inter-simulator communication.

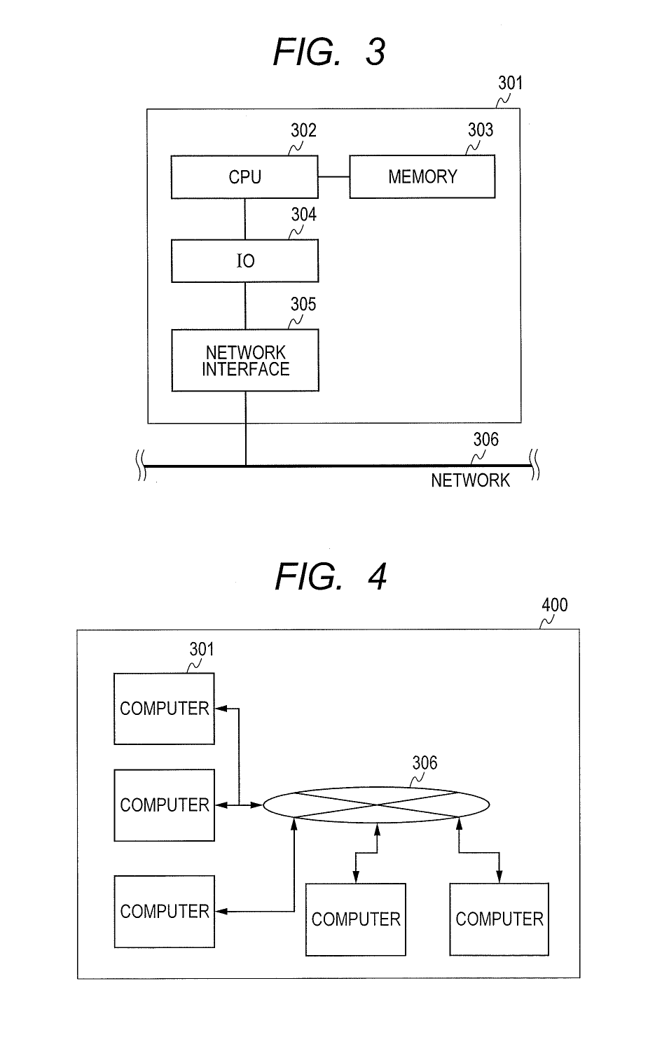

FIG. 3 shows an example of a basic configuration of a computer on which the management node 100 and the execution node 102 of the computer simulation system in FIG. 1 run. A computer 301 in FIG. 3, in which a CPU 302, a memory 303, and an IO bridge 304 are connected, is connected to an external network 306 via a network interface 305 connected to the IO bridge 304. Of course, it is not limited to this configuration, but various configurations having an equivalent function are possible.

FIG. 4 shows an example of a computer cluster, in which multiple computers 301 are connected to each other via the external network 306. An appropriate number of computers 301 are selected from the multiple computers 301 included in a computing cluster 400 in FIG. 4 for each simulation, and the selected computers 301 run as the execution nodes 102. Also, one computer 301 is selected, and the selected computer 301 runs as the management node 100.

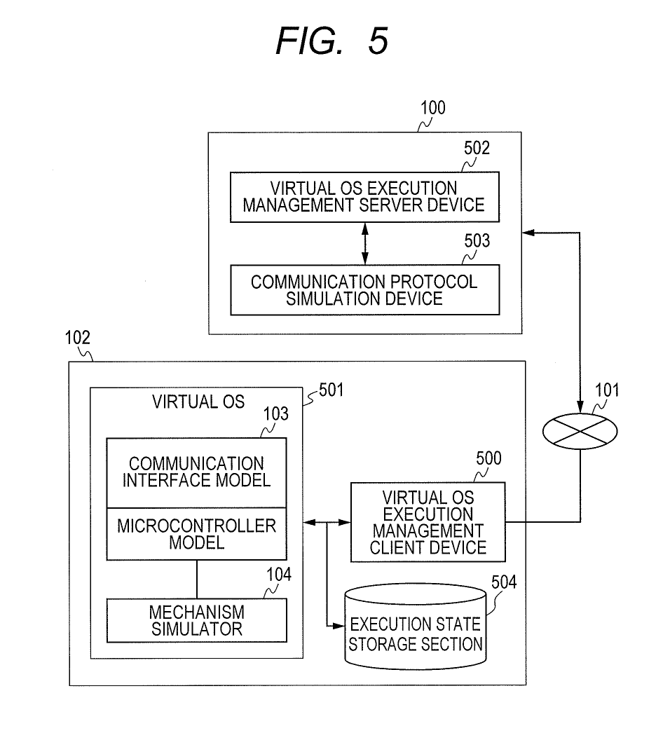

FIG. 5 shows an example of a detailed configuration of the computer simulation system according to the present embodiment. Although only one execution node 102 is shown in FIG. 5 for the sake of simplicity, multiple execution nodes are connected as shown in FIG. 1.

In FIG. 5, the management node 100 including a computer runs with a virtual OS execution management server device 502 and a communication protocol simulation device 503 connected to each other. The virtual OS execution management server device 502 issues an instruction for storing an execution state of a virtual OS 501 in each execution node 102, controls a period of storing the execution state, and instructs returning, that is, re-execution, via the network 101. The communication protocol simulation device 503 performs data exchange between the execution nodes 102 and arbitrates a sequence of the data exchange according to a communication protocol, which is an object to be simulated, via the network 101. In the communication protocol simulation device 503, a user can define a bus transmission sequence determination formula and a communication latency calculation formula so as to enable multiple communication protocols.

The virtual OS execution management server device 502 and the communication protocol simulation device 503 respectively include a virtual OS execution control program and an inter-simulation communication control program, which are executed on the computer of the management node 100.

As described sequentially below, the virtual OS execution management server device 502 is connected to all the execution nodes 102 and the communication protocol simulation device 503 via a network, and has a function to manage the execution nodes 102 according to a communication request from the execution nodes 102 so that simulation execution times on all the connected execution nodes 102 are the same and a function to transmit a communication sequence between the execution nodes 102 and delay times thereof to the execution nodes 102 on the basis of information related to various network operations acquired from the communication protocol simulation device 503 and insert the delay times into simulations executed by the execution nodes 120. The communication protocol simulation device 503 has libraries that enable simulation of a basic operation of a communication protocol and has a function to enable simulation of any network protocol when a user combines libraries.

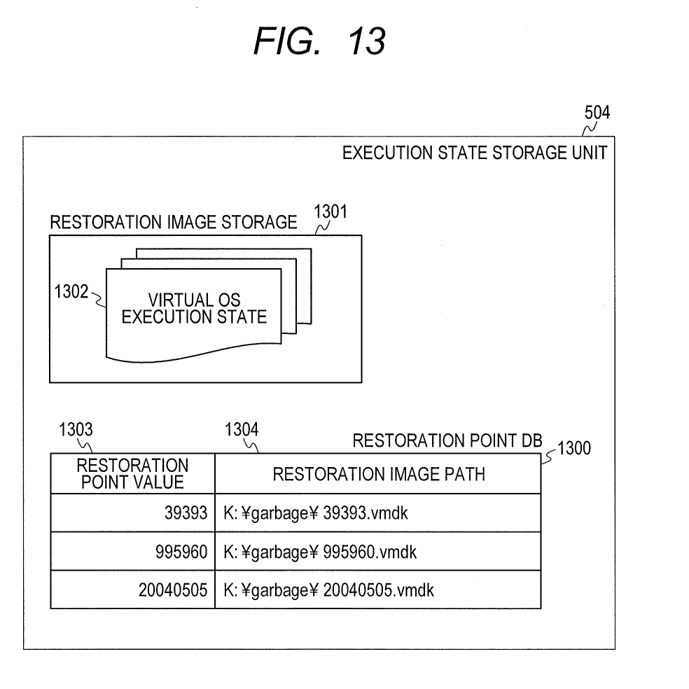

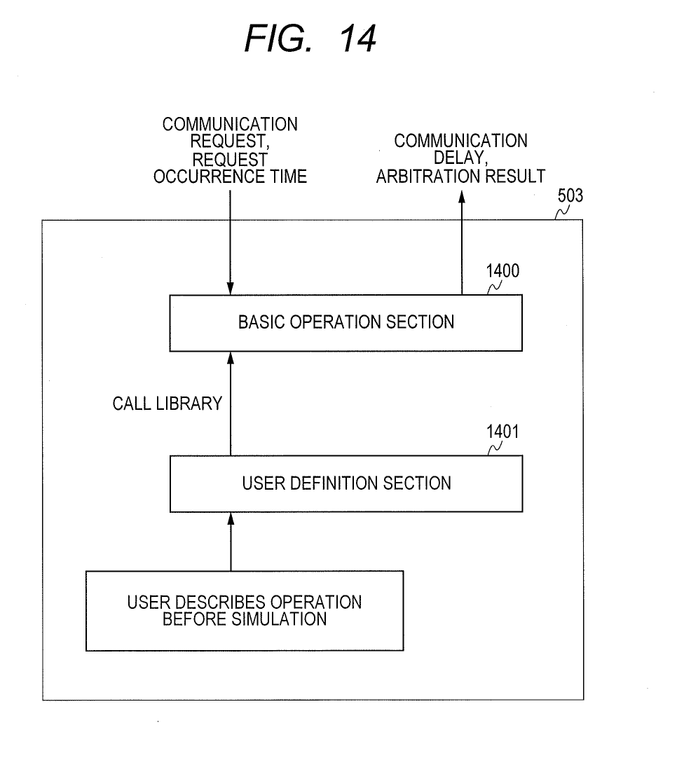

On the other hand, the execution node 102 including a predetermined number of computers runs with a virtual OS (Operating System) 501 on which a simulation assigned to the execution node 102 runs, a virtual OS execution management client device 500, and an execution state storage section 504 connected to each other. The virtual OS execution management client device 500 receives an instruction from the virtual OS execution management server device 502, stores a state of the virtual OS 501, and performs returning. The execution state storage section 504 stores a combination of a snapshot in which a mid-execution state of the virtual OS 501 is stored as a file and a simulation time when the mid-execution state is stored. The execution state storage section 504 has a restoration point database (DB) 1300 and a restoration image storage 1301. The details of the execution state storage section 504 will be described later with reference to FIG. 13.

The virtual OS execution management client device 500 is executed on the computer of the execution node 102 and is a part of the virtual OS execution control program in the same way as the virtual OS execution management server device 502. The virtual OS execution management client device 500 has a function to instruct each virtual OS 501 on the execution node 102 to stop execution or store an execution state. Also, the virtual OS execution management client device 500 has a function to instruct the execution state storage section 504 to add an entry or delete a search entry. Further, the virtual OS execution management client device 500 has a function to receive a re-execution instruction from the management node 100, search the restoration point DB 1300 of the execution state storage section 504 on the basis of the re-execution instruction, find an optimal restoration image, call the optimal restoration image from the restoration image storage 1301, and re-execute the virtual OS 501. When the virtual OS execution management client device 500 searches for an execution state of a virtual OS to be re-executed, the virtual OS execution management client device 500 searches for the execution state by using an execution time of a simulation being executed as a key.

A simulation assigned to the virtual OS 501 of the execution node 102 basically simulates an ECU and a mechanism controlled by the ECU. Therefore, one microcomputer simulator 701 shown in FIG. 7, one or multiple mechanical system simulators 703, and one or multiple electronic system simulators 702 operate collaboratively. Either the above-described polling method or the speculative communication method can be used for the communication between the simulations.

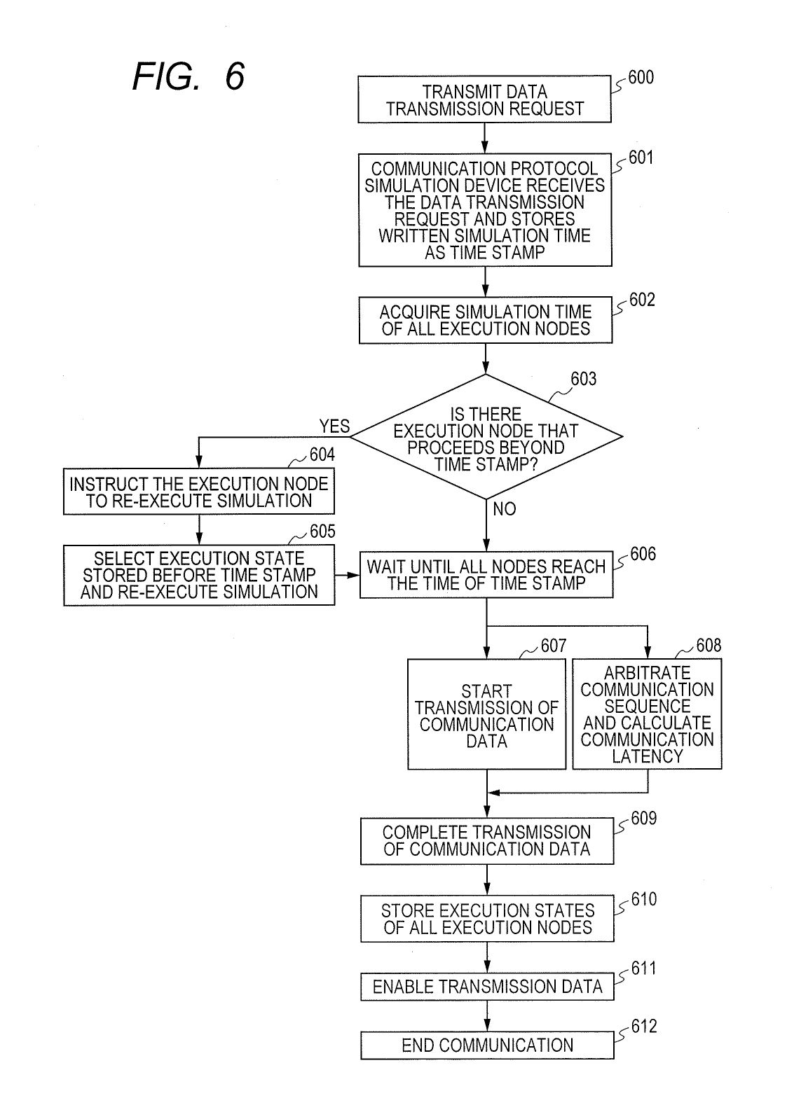

FIG. 6 shows an example of a process flow of a simulation using the speculative communication method by the simulation system of the present embodiment.

In FIG. 6, when an execution of a simulation in an execution node 102 reaches a stage for transmitting data to the in-vehicle communication controller 209, the execution node 102 transmits a data transmission request 800 to the management node 100 (step 600).

The communication protocol simulation device 503 of the management node 100 receives the data transmission request 800. The communication protocol simulation device 503 stores a simulation time written in the data transmission request 800 in a memory as a time stamp (step 601).

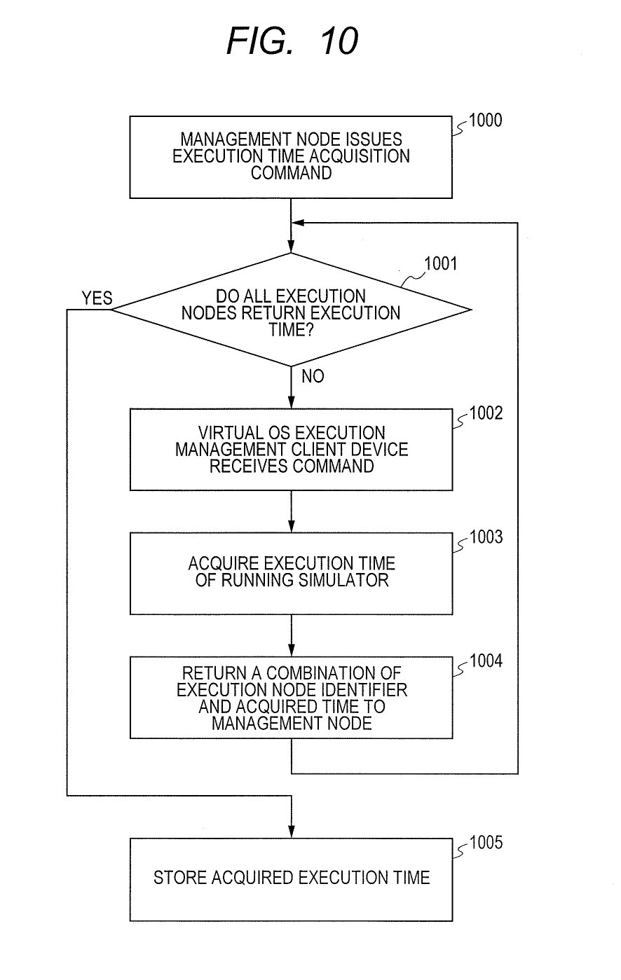

Then, the communication protocol simulation device 503 inquires of all the execution nodes 102 connected to the management node 100 about the simulation time and acquires the simulation time (step 602). The details of a process flow of step 602 will be described later with reference to FIG. 10.

The communication protocol simulation device 503 compares the acquired simulation time of each execution node 102 and the time stamp thereof, and determines whether or not there is a simulation time having a value larger than the time stamp (step 603).

If there are one or multiple execution nodes 102 having a simulation time larger than the time stamp, the communication protocol simulation device 503 issues a re-execution instruction of the simulation to these execution nodes 102 (step 604).

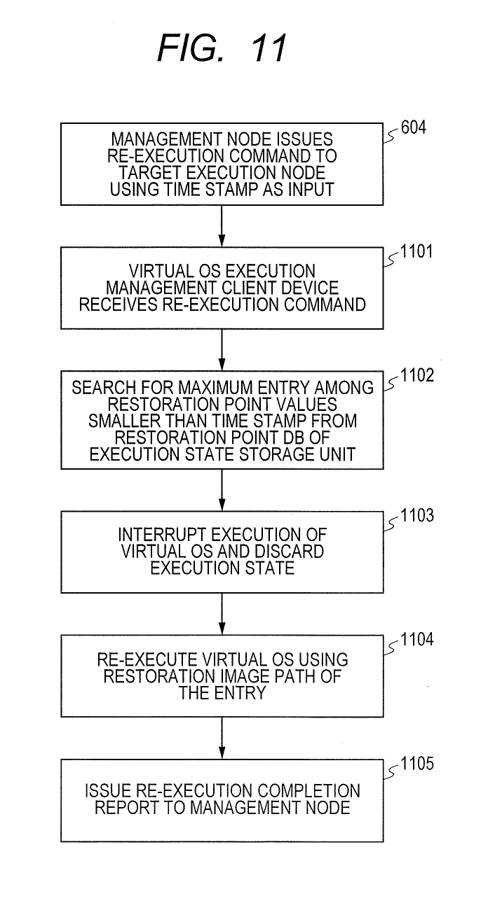

The virtual OS execution management client device 500 of the execution node 102 which receives the re-execution instruction searches for a snapshot corresponding to a latest simulation time before the time stamp, and re-executes the simulation by using the snapshot (step 605). The details of a process flow of step 602 will be described later with reference to FIG. 11.

When each execution node 102 reaches the time stamp, the execution node 102 transmits a time stamp reach report to the management node 100, and stops the execution of the simulation until all other execution nodes 102 transmit the time stamp reach report (step 606).

When the simulation time of all the execution nodes 102 becomes the same, the management node 100 starts transmitting communication data (step 607).

At the same time, the communication protocol simulation device 503 of the management node 100 calculates time in simulation at which the transmitted data becomes valid in each execution node 102 on the basis of a predetermined bus transmission sequence determination formula and communication latency calculation formula (step 608). The calculated time is transmitted to each execution node 102 as a commit time stamp (step 609).

As shown in FIG. 13, the execution states of the virtual OS 501 of all the execution nodes 102 are stored in the restoration image storage 1301 of the execution state storage section 504 in each execution node 102 as a file in combination of an OS execution state 1302 and a time stamp (step 610).

After transmission, the simulation of each execution node 102 is restarted. The data transmitted at this time is made valid and used in the simulation when the simulation time of each execution node 102 reaches the commit time stamp (step 611).

When all the execution nodes 102 reach the commit time stamp, the communication ends (step 612).

FIG. 8 shows an example of a data type included in the data transmission request of the present embodiment, which is described in steps 600 and 601 in FIG. 6.

As shown in FIG. 8, the data transmission request transmitted from each execution node 102 includes a communication setting ID 801, a simulation time 802, a transmission length 803, and transmission contents 804.

A column of the communication setting ID 801 contains an identifier specifying a communication delay and a bus transmission sequence determination formula, which are used by the communication protocol simulation device 503. A column of the simulation time 802 contains the simulation time of the execution node 102 which transmits the data transmission request 800. A column of the transmission length 803 contains the size of the data to be transmitted by the execution node 102. A column of the transmission contents 804 contains the data main body in binary format.

FIG. 10 shows details of step 602 of the process flow of the simulation using the speculative communication method by the simulation system of the present embodiment shown in FIG. 6.

First, the virtual OS execution management server device 502 of the management node 100 issues an execution time acquisition command to all the execution nodes 102 connected to the management node 100 (step 1000).

Next, the virtual OS execution management server device 502 waits until the execution time is returned from all the execution nodes 102 (step 1001).

When the virtual OS execution management client device 500 of each execution node 102 receives the execution time acquisition command (step 1002), the virtual OS execution management client device 500 inquires an execution state of the simulation executed in the virtual OS 501. At this time, one of simulators executed in the virtual OS 501 returns execution time thereof (step 1003). To acquire the execution time of the simulator, it is possible to use a function specific to the simulator or add a virtual block for returning the execution time in an object to be simulated.

The virtual OS execution management client device 500 returns the acquired simulation execution time and an identifier of the execution node 102 as a pair to the virtual OS execution management server device 502 (step 1004). Steps 1002 to 1004 are executed by the virtual OS execution management client device 500. As described above, the virtual OS execution management client device 500 is a part of the virtual OS execution control program on the client side of the present embodiment.

The virtual OS execution management server device 502 confirms that the execution time is checked by all the execution nodes 102 and stores the execution time (step 1005).

FIG. 11 shows details of step 605, which is executed by the virtual OS execution management client device 500 of the execution node 102 which is instructed to re-execute simulation, in the process flow of the simulation using the speculative communication method by the simulation system of the present embodiment shown in FIG. 6.

In step 603 in FIG. 6, the virtual OS execution management server device 502 issues a re-execution command including a node identifier indicating a re-execution target node and a time stamp as a pair to the virtual OS execution management client device 500 of the execution node 102 having simulation time progressing further than the time stamp (step 604).

When the virtual OS execution management client device 500 of the execution node 102, which is the re-execution target node, receives the re-execution command (step 1101), the virtual OS execution management client device 500 searches the restoration point database (DB) 1300 of the execution state storage section 504 shown in FIG. 13. The search is performed using a search condition for acquiring a restoration image path of a maximum entry among restoration points having a restoration point value smaller than the received time stamp (step 1102).

Next, the virtual OS execution management client device 500 stops execution of the virtual OS 501 and discards results acquired by then (step 1103). Then, by loading an execution state image file of the virtual OS located in the restoration image path acquired in step 1102 from the restoration image storage 1301 of the execution state storage section 504 to the virtual OS 501, the simulation is re-executed from near the time stamp specified by the virtual OS execution management server device 502 (step 1104).

Finally, the virtual OS execution management client device 500 which has re-executed the simulation issues a re-execution completion report to the virtual OS execution management server device 502 (step 1105).

As described above, in the present embodiment, in step 610 in FIG. 6, all the execution nodes stores an execution state when the communication ends, so that simulation is prevented from regressing in transmission thereafter. However, if the communication period is long, re-execution overhead increases when a hazard occurs. To reduce the overhead, it is necessary to store an execution state at least once between the end of communication and the next start of the communication. Therefore, as an exemplary embodiment of the present embodiment, an adaptive control of the execution state storage period based on the communication periods by the previous communication period is performed.

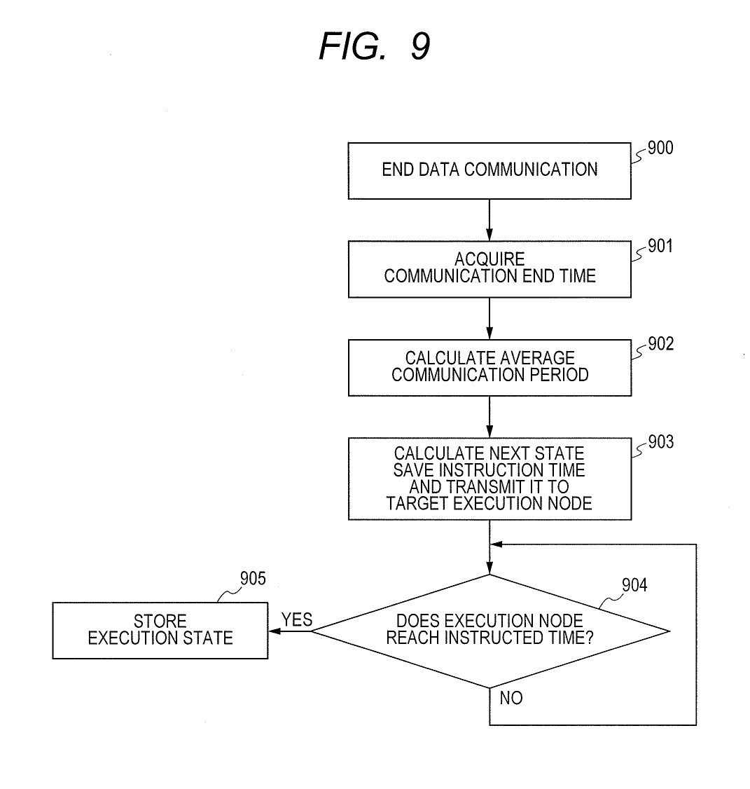

FIG. 9 is a diagram showing an example of an operation flow of the adaptive control as an exemplary embodiment of the present embodiment. In FIG. 9, the adaptive control is started by the virtual OS execution management server device 502 of the management node 100 (step 900), triggered by the end of the communication operation on the simulation (step 612).

First, the virtual OS execution management server device 502 acquires communication end time from the communication protocol simulation device 503 (step 901). Then, an average communication period pattern is calculated from the communication end time stored by then (step 902). The next state storage instruction time is calculated by, for example, communication end time+average communication period/2, and transmitted to the target execution node 102 (step 903).

Each execution node 102 advances execution of the simulation to the specified state storage instruction time (step 904).

Finally, while the specified state storage instruction time is reached, the simulation execution state is stored, and the simulation is restarted (step 905).

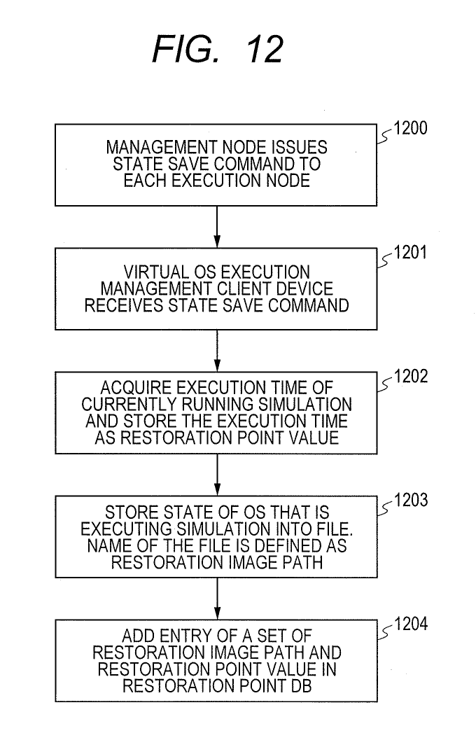

FIG. 12 is a diagram showing an example of a detailed flow for storing the execution state in step 905 in FIG. 9. For example, the stored execution state is used in step 605 in FIG. 6.

In the process flow in FIG. 12, first, the virtual OS execution management server device 502 of the management node 100 issues an execution state storage command (step 1200).

When the virtual OS execution management client device 500 of the execution node 102 receives the execution state storage command (step 1201), the virtual OS execution management client device 500 acquires the execution time of the simulation being executed in the virtual OS 501 and temporarily stores the execution time as a restoration point value (step 1202).

Next, the virtual OS execution management client device 500 temporarily stops the execution of the virtual OS 501 and stores the OS execution state 1302 in a file stored in the restoration image storage 1301 as an execution state image. The name of the file is temporarily stored as a restoration image path (step 1203). Finally, an entry of a set of the restoration point value and the restoration image path is added to the restoration point DB 1300 shown in FIG. 13 (step 1204).

FIG. 13 shows details of a configuration example of the execution state storage section 504 shown in FIG. 5 of the present embodiment.

In FIG. 13, the execution state storage section 504 provided in the storage section includes the restoration image storage 1301 that stores the execution state of the virtual OS 501 as a file and the restoration point DB 1300 that makes it possible to search for a stored restoration image by the simulation time at which the restoration image is stored. The restoration point DB 1300 includes a restoration point value 1303 and a restoration image path 1304. On the other hand, the OS execution states 1302 are accumulated in the restoration image storage 1301. Functions provided by the execution state storage section 504 are entry addition, entry search, and entry deletion.

The entry addition is performed when the execution state is stored as described in FIG. 12. In the entry addition, one virtual OS execution image file 1301 is stored in the restoration image storage, and the restoration image path 1304, which is a file path of the virtual OS execution image file 1301, and the restoration point value 1303, which is the simulation execution time, are stored in the restoration point DB 1300.

The entry search is used when the simulation is re-executed. The restoration point DB 1300 is searched by using the time stamp transmitted from the virtual OS execution management server device 502 as a key and an optimal restoration image of the virtual OS is returned.

The entry deletion is automatically performed in all the execution nodes 102 when the simulation ends, and all the entries in the restoration point DB 1300 and the virtual OS execution image file 1301 can be deleted.

The restoration point DB 1300 does not differentiate restoration images in multiple simulations. Therefore, by deleting all the entries when the simulation ends, it is possible to prevent a wrong OS image from being taken between simulations.

FIG. 14 is a functional block diagram showing a specific example of a functional configuration of the communication protocol simulation device 503 according to the present embodiment. As described above, the communication protocol simulation device 503 is realized as an inter-simulation communication control program running on the management node 100 including a computer. As described above, the communication protocol simulation device 503 has libraries that enable simulation of a basic operation of a communication protocol and has a function to enable simulation of any network protocol when a user combines libraries. The communication protocol simulation device 503 receives a communication request and request occurrence time sent from the execution node 102 from the virtual OS execution management server device 502, and provides a communication sequence between the execution nodes which is an arbitration result and a communication delay as network operation information.

To realize such an operation, as shown in FIG. 14, the communication protocol simulation device 503 includes two functional blocks, which are a basic operation section 1400 and a user definition section 1401.

As shown in FIG. 14, the basic operation section 1400 provides an interface with the virtual OS execution management server device 502. The communication request and the request occurrence time transmitted from the execution node 102 are inputted into the basic operation section 1400, and the basic operation section 1400 outputs an arbitration result which is the sequence of processing the communication requests and the communication delay. The sequence and the communication delay of the basic operation section 1400 can be determined by a usual method. The basic operation section 1400 includes functions for performing operations necessary for actual network operations, that is, delay calculation, management of event queue, and state transition, and provides a common library of delay description, state transition description, event queue processing, and the like.

On the other hand, the user definition section 1401 operates as a program in which the above-described functions included in the basic operation section 1400 are combined to realize a network behavior desired by a user for each object to be simulated. The user describes the operation before a simulation. At this time, the user definition section 1401 calls the above-described library from the basic operation section 1400 and describes a communication state transition, the size of an event queue, a delay of each communication operation, and the like based on a programming language by using the called library.

Although, in the management node 100 of the present embodiment, the operation of the communication simulation is linked to the control of the OS that executes the simulation, such a configuration is employed in order to separate the simulation of the communication from the control of the OS.

Although an embodiment of the present invention has been described in detail, the present invention is not limited to the embodiment described above, and various modifications are included in the present invention. The above embodiment is described in detail for better understanding of the present invention, and the present invention is not limited to one having all the constituent elements described above. A part of the configuration of the embodiment and a modified example thereof can be modified by addition, deletion, and replacement of another element. Needless to say, part or all of the above-described configurations, functions, and processing sections can be realized by hardware by designing them by an integrated circuit, or can be realized by software by designing them by a program.

The present invention can be applied to a computer system in which multiple software products run in conjunction with each other or a program in a development system.

It should be understood by those skilled in the art that various modifications, combinations, sub-combinations and alterations may occur depending on design requirements and other factors insofar as they are within the scope of the appended claims or the equivalents thereof.

1. A computer system comprising:
a management node; and
a plurality of execution nodes having a simulator that executes a simulation,
wherein the management node and the execution nodes are connected via a network, and
when one of the execution nodes transmits a data transmission request to another execution node via the management node at a predetermined time, if simulation time of the simulator of the other execution node advances further than the predetermined time, the management node issues an re-execution instruction to the other execution node to re-execute the simulation from a restoration point before the predetermined time to the predetermined time and controls the other node to transmit the data requested to be transmitted after the re-execution to the execution node that transmitted the data transmission request.

2. The computer system according to claim 1, wherein
the execution node includes a virtual operating system (OS) that functions as the simulator that executes the assigned simulation, a virtual OS execution management client device that manages execution of the virtual OS, and an execution state storage section that stores an execution state of the virtual OS, and
the virtual OS execution management client device controls the virtual OS to re-execute the simulation from the restoration point before the predetermined time to the predetermined time according to the re-execution instruction from the management node.

3. The computer system according to claim 2, wherein
the execution state storage section includes a restoration point database (DB) that accumulates a combination of simulation time of the virtual OS and a file path in which an execution state of the virtual OS is stored as a restoration image and a restoration image storage that stores the restoration image.

4. The computer system according to claim 3, wherein
the execution state storage section deletes entries of the restoration point DB and the restoration image storage when the simulation ends.

5. The computer system according to claim 2, wherein
the management node includes a communication protocol simulation device that has a library that enables simulation of a basic operation of any communication protocol and generates network operation information, and a virtual OS execution management server device that is connected to the execution nodes and the communication protocol simulation device and manages so that the simulation time of the execution nodes is the same according to the data transmission request from the execution nodes.

6. The computer system according to claim 5, wherein
the virtual OS execution management server device of the management node performs control so that a communication sequence between the execution nodes and delay time are inserted into the simulation executed in the execution node on the basis of the network operation information acquired from the communication protocol simulation device.

7. The computer system according to claim 5, wherein
the virtual OS execution management server device of the management node controls a period of storing an execution state of the virtual OS of the execution node on the basis of a period of communication generated in the simulation.

8. A simulation method of a computer system in which a management node and a plurality of execution nodes that respectively execute simulations are connected via a network, wherein
when one of the execution nodes transmits a data transmission request to another execution node via the management node at a predetermined time, if simulation time of the simulation of the other execution node advances further than the predetermined time, the management node issues an re-execution instruction to the other execution node to re-execute the simulation from a restoration point before the predetermined time to the predetermined time and controls the other node to transmit the data requested to be transmitted after the re-execution to the execution node that transmitted the data transmission request.

9. The simulation method according to claim 8, wherein
the execution node executes the simulation assigned by a virtual OS running in the execution node and re-executes the simulation from the restoration point before the predetermined time to the predetermined time by the virtual OS according to the re-execution instruction from the management node.

10. The simulation method according to claim 9, wherein
the execution node stores a combination of simulation time of the virtual OS and a file path in which an execution state of the virtual OS is stored as a restoration image and the restoration image in a storage section of the execution node.

11. The simulation method according to claim 9, wherein
the management node includes a library that enables simulation of a basic operation of any communication protocol and manages so that the simulation time of the execution nodes is the same according to the data transmission request from the execution nodes.

12. The simulation method according to claim 11, wherein
the management node controls a period of storing an execution state of the virtual OS of the execution node on the basis of a period of communication generated in the simulation.

13. A program executed by a processing unit of a plurality of execution nodes that respectively execute simulations or a processing unit of a management node connected to the execution nodes that are connected to each other via a network, the program causing,
the processing unit of the management node to, when one of the execution nodes transmits a data transmission request to another execution node via the management node at a predetermined time, determine whether or not simulation time of the simulation of the other execution node advances further than the predetermined time, and if determining that the simulation time advances further than the predetermined time, issue an re-execution instruction to the other execution node to re-execute the simulation from a restoration point before the predetermined time to the predetermined time and control the other node to transmit the data requested to be transmitted after the re-execution to the execution node that transmitted the data transmission request.

14. The program according to claim 13, wherein
the program causes the processing unit of the management node to operate so that a virtual OS running in the processing unit executes the assigned simulation and the virtual OS re-executes the simulation from the restoration point before the predetermined time to the predetermined time according to the re-execution instruction from the management node.

15. The program according to claim 13, wherein
the program causes the processing unit of the management node to control a period of storing an execution state of the virtual OS that executes the simulation assigned to the execution node on the basis of a period of communication generated in the simulation.
